(19) United States
(12) Patent Application Publication
(10) Pub. No.: US 2009/0305060 A1
(43) Pub. Date: Dec. 10, 2009

(54) Hot Melt Adhesive for Microwave Heating

(76) Inventors: Marcel Roth, Dusseldorf (DE); Petra Padurschel, Erkrath (DE); Erik Niehaus, Dusseldorf (DE); Gunter Hoffman, Bopfingen (DE)

Correspondence Address: Henkel Corporation, 10 Finderne Avenue, Bridgewater, NJ, 08807, US

(21) Appl. No.: 12/483,657

(22) Filed: Jun. 12, 2009

Related U.S. Application Data
(63) Continuation of application No. PCT/EP2007/060188, filed on Sep. 26, 2007.

(30) Foreign Application Priority Data
Dec. 14, 2006 (DE) 10 2006 059 462.2

(51) Int. Cl. B32B 17/10; C08L 31/04; C08K 3/10; C08K 3/22; B32B 27/10; B32B 27/30; B32B 7/12; B32B 7/00

(52) U.S. Cl. 428/442; 525/384; 524/563; 524/435; 524/431; 428/514; 428/522; 156/327; 156/344

(57) ABSTRACT

The invention relates to a hot melt adhesive, when irradiated with microwave radiation, heats up and loses its adhesive properties. The invention further relates to a process for bonding and opening package with the hot melt adhesives. The hot melt adhesive is particularly well suited for food packages.

### CROSS REFERENCE TO RELATED APPLICATIONS

This application is a continuation of PCT/EP2007/060188 filed Sep. 26, 2007, which claims the benefit of DE 10 2006 059 462.2, filed Dec. 14, 2006, the complete disclosures of which are hereby incorporated by reference in their entirety.

The invention relates to a non-crosslinking hot melt adhesive that, when irradiated with microwaves, heats up and loses its adhesive properties. The invention further relates to a process for bonding of packaging materials using non-reactive melt adhesives, wherein the adhesive bond can be released again by heating with microwaves.

Non-reactive melt adhesives are known. EP 1124911, for example, describes melt adhesives manufactured on the basis of poly-α-olefins. These are described in particular for application of the melt adhesive by spraying. EP 388712 describes melt adhesives based on ethylene-acrylic acid-acrylic ester copolymers. These copolymers serve for the bonding of solid substrates. Furthermore, EP 890584 describes melt adhesives that are based on polyolefins manufactured by metallocene-catalyzed synthesis. Melt adhesives of this kind are notable for a particularly narrow molecular weight distribution and a narrow melting range.

EP 498998 describes a process for heating polymer material wherein the polymer material contains dispersed ferromagnetic particles. These mixtures can be heated by microwave irradiation so that the melting temperature of the polymer material is exceeded. EP 629490 describes polymers that are meltable or crosslinkable at high temperature, which contain finely divided powders made of substances that form dipoles and are sensitive to microwave radiation. The compositions are not further specified.

Also known is DE 19924138, which describes melt adhesive compositions that contain nanoscale ferromagnetic particles. The document describes the fact that adhesive bonds of this kind can be heated by the action of electromagnetic radiation, the adhesive bond then being readily releasable.

WO 92/09503 is also known. This describes packaging units that are transparent to microwave radiation and contain a hot melt adhesive that is heatable by microwaves and then transitions into the liquid state. The processes described therein for obtaining melt adhesives activatable by microwave radiation include additives that hold water in the polymer, or substances that retain hygroscopic water. It is noted as a disadvantage that such additives negatively influence the properties of the melt adhesive. Further described therein are solid additives such as, for example, carbon black that, when mixed in, make the melt adhesive heatable by means of microwave radiation. A detailed listing is given of various particulate substances that, as such, can be heated by microwave radiation and can be mixed into the melt adhesive.

The aforesaid processes have the disadvantage that added solid additives of this kind generally have a negative influence on the appearance of the melt adhesive. Such substances are, moreover, expensive. In addition, such substances are often not permissible in conjunction with food packaging materials. The retention of water in the melt adhesive results in poor adhesion properties, can cause bubbles upon heating, or can negatively influence cohesion.

It is therefore an object of the present invention to make available a melt adhesive that is suitable for the bonding of packaging materials in the food sector, and by the application of microwave radiation is heatable and the adhesive bond produced therewith is releasable.

The invention is achieved by a non-reactive thermoplastic melt adhesive that is heatable by microwave radiation, characterized in that at least 50 wt %, based on the quantity of base polymers, of a thermoplastic polymer of ethylene-vinyl acetate is contained, optionally additionally thermoplastic polymers containing polar groups, as well as 0.5 to 15% by weight of polyols having a boiling point above 120° C.

Also described is a process for bonding of substrates using non-reactive melt adhesives heatable by means of microwave radiation, wherein the melt adhesive contains at least 50% by weight ethylene-vinyl acetate copolymers, optionally additionally contains thermoplastic polymers that comprise polar groups, as well as 0.5 to 15% by weight of polyols having a boiling point above 120° C., wherein the adhesive bond is releasable by irradiating the bonded substrates with microwave radiation.

Non-crosslinking melt adhesives usually contain 15 to 80% by weight of thermoplastic base polymers, which impart to the adhesive its fundamental properties such as melt viscosity and melt behavior, adhesion, and stability. It is essential to the invention that at least 50% by weight of the base polymers are made up of ethylene-vinyl acetate copolymers. Melt adhesives that contain at least 70% by weight thermoplastic EVA polymers, based on the quantity of base polymers, are particularly suitable.

Ethylene-vinyl acetate (EVA) copolymers are common. These are copolymers based on vinyl acetate and ethylene, which optionally can also contain further monomers polymerized in. They are generally intended to be crystalline or partly crystalline, and to have a softening point above 50° C. The vinyl acetate content is to be between 10 and 50% by weight, preferably between 15 and 40% by weight. Important functional parameters such as glass transition temperature (T_{G}), melting point, or softening point can be influenced by way of the selection of monomers.

Further monomers can additionally be contained, for example C₃ to C₁₀ unsaturated carboxylic acids such as acrylic acid, methacrylic acid, crotonic acid, isocrotonic acid; α-β-unsaturated C₄ to C₁₀ alkylenedicarboxylic acids, such as maleic acid, fumaric acid, or itaconic acid.

Further monomers that can be polymerized into the EVA are, for example, C₁ to C₁₅ alkyl vinyl esters, C₁ to C₁₅ alkyl(meth)acrylate, C₁ to C₁₅ alkyl esters of dicarboxylic acids, for example such as alkyl fumarate, methyl (meth)acrylate, butyl (meth)acrylate, 2-ethylhexyl (meth)acrylate; C₁ to C₆ hydroxyalkyl (meth)acrylate such as hydroxyethyl or hydroxypropyl (meth)acrylate; acrylonitrile, acrylamide, methacrylamide, N-methylolacrylamide. Such monomers can be contained in quantities from 0.2 to 10% by weight, in particular up to 5% by weight, in the EVA copolymers. The molecular weight (M_{N}) of such EVA polymers is usually between 3000 and 200,000 g/mol, in particular up to 100,000 g/mol (arithmetically averaged molecular weight (M_{N}) as obtainable by gel permeation chromatography).

Selection of the EVA polymers, processes for the manufacture thereof, and suitable comonomers are known to the skilled artisan. He or she can select then on the basis of applications-engineering properties, for example melt temperature, melt viscosity, adhesion properties, or compatibility with other constituents.

Portions of additional melt adhesive base polymers, polymers differing from EVA polymers, can also be contained in a melt adhesive that is suitable according to the present invention. Such melt adhesive base polymers are understood as thermoplastic synthetic polymers that substantially determine properties that are important for melt adhesives, such as adhesion, strength, and temperature behavior. Examples of such polymers are polyamide resins, copolyamides, polyether amides, polyester amides, polyesters, polyethers, polycarbonates; thermoplastic elastomers; reactive and non-reactive linear or branched thermoplastic polyurethanes; polymerizates such as ethylene-acrylate, propylene-hexene, SIS, SBS, SEBS copolymers; polyolefins, such as amorphous α-olefin copolymers (APAO), semicrystalline polyolefins, in particular propylene (PP) or ethylene (PE) copolymers.

Non-reactive polar melt adhesive base polymers are particularly suitable for melt adhesives suitable according to the present invention, for example polar-modified polyethylene or polypropylene, polyamides, polyesters, polyester amides, polyolefin copolymers manufactured by metallocene catalysis, polyurethanes. Polymers that comprise a large number of polar groups in the structure are particularly suitable. Examples of such structures are urethane or urea groups, carboxyl, ester, or amide groups, OH or NH groups. Such polymers are known to the skilled artisan.

The melt adhesive in the compositions according to the present invention can additionally contain at least one thermoplastic base polymer, selected from the classes indicated above, having a molecular weight from 2000 to 200,000 g/mol. Care must be taken, however, that the various polymers result in a substantially homogeneous mixture upon processing and bonding, i.e. no phase separation is to occur upon melting or storage, thus ensuring a homogeneous adhesive bond. The quantity of additional thermoplastic base polymers is to be 0 to 50% by weight, preferably 0 to 30% by weight, based on the base polymer material.

Especially to be selected are those polymers that contain no substances harmful to health, including low-molecular-weight migratable substances. They are preferably to be approved for use in the food industry.

It is essential to the present invention that the melt adhesive contains between 0.5 and 15% of at least one polyol that has a boiling point above 120° C. Appropriate polyols are the usual known 2-, 3-, or polyfunctional alcohols. These can be solid at room temperature, or are liquid. Examples of such alcohols are diols or triols such as glycol, diethylene glycol, triethylene glycol, glycerol, ethoxylated glycerol derivatives, neopentyl glycol, trimethylolpropane, trimethylolethane, pentaerythritol, hexanetriol, or sugar alcohols based on hexoses or pentoses, such as glucose, mannitol, sorbitol, xylose, arabinose. Mixtures of different alcohols can also be used. Low-molecular-weight polyvinyl alcohols can also be used.

The boiling point of the polyols used is to be selected in particular so that it is above the melting temperature of the melt adhesive. It is, in particular, to be above 150° C., in particular above 200° C. The upper limit can be up to 350° C., or the alcohol can decompose at high temperature. It is advisable if the polyols selected are approved for the use of packaging materials, and adhesive for packaging materials, for the food industry.

The polyols are in particular to have a molecular weight below 1000, preferably below 700, in particularly below 400. They can, in particular, be solid at 20° C., but they can also be liquid substances. The dipole moment of the polyols is to be high, for example above 1.85 debye, in particular above 2.3 debye. A particular embodiment utilizes tri- to hexavalent alcohols.

The melt adhesives can contain further constituents in addition to the constituents necessary according to the present invention, such as EVA polymer, optionally additional thermoplastic polymers, and polyols having a boiling point above 120° C. In a preferred embodiment, the melt adhesive according to the present invention contains at least one tackifying resin.

The resin produces additional tackiness, and improves the compatibility of the hot melt adhesive components. These resins are, in particular, those that possess a softening point from 70 to 150° C. (ring and ball process, DIN 52011). These are, for example, aromatic, aliphatic, or cycloaliphatic hydrocarbon resins, as well as modified or hydrogenated versions thereof. Examples thereof are aliphatic or alicyclic petroleum hydrocarbon resins and hydrogenated derivatives. Further resins usable in the context of the invention are hydroabietyl alcohol and its esters, in particular its esters with aromatic carboxylic acids such as terephthalic acid and phthalic acid; preferably modified natural resins such as resin acids from balsam resin, tall rosin, or wood rosin, for example fully saponified balsam resin, or alkyl esters of (optionally) partially hydrogenated colophon having low softening points, such as e.g. methyl, diethylene glycol, glycerol, and pentaerythritol esters; terpene resins, in particular copolymers of terpene, such as styrene/terpene, α-methyl styrene/terpene, phenol-modified terpene resins, and hydrogenated derivatives thereof; acrylic acid copolymerizates, by preference styrene-acrylic acid copolymers, and reaction products based on functional hydrocarbon resins. It is preferred to use partially polymerized tall rosin, hydrogenated hydrocarbon resins, or colophon/glycerol esters, individually or mixed.

The resin has a low molecular weight of less than 2000 g/mol, in particular less than 1500 g/mol. It can be chemically inert or it can optionally also contain functional groups such as, for example, OH groups, carboxyl groups, or double bonds. The quantity of resin is to be between 0 and 40% by weight based on the melt adhesive, in particular 5 to 30% by weight. Compatibility of the polyol constituents with the base polymers can also be improved with the resins.

Additives that influence specific properties of the adhesive such as, for example, cohesive strength, viscosity, softening point, or processing viscosity are contained as further constituents in the melt adhesive according to the present invention. These are to be understood as, for example, plasticizers, stabilizers, waxes, adhesion promoters, antioxidants, or similar additives. The quantity is to be up to 30% by weight. Multiple additives can also be used as a mixture. Fillers can additionally be used to enhance strength.

Plasticizers are utilized by preference in order to adjust the viscosity or flexibility, and are contained generally at a concentration from 0 to 20% by weight, by preference from 2 to 15% by weight. Suitable plasticizers are, for example, medicinal white mineral oils, naphthenic mineral oils, polypropylene, polybutene, and polyisoprene oligomers, hydrogenated polyisoprene and/or polybutadiene oligomers, benzoate esters, phthalates, adipates, vegetable or animal oils and derivatives thereof. Hydrogenated plasticizers are selected, for example, from the group of the paraffinic hydrocarbon oils. Polypropylene glycol and polybutylene glycol, as well as polymethylene glycol, are also suitable. Esters are also optionally used as plasticizers, e.g. liquid polyesters and glycerol esters, or plasticizers based on aromatic dicarboxylic acid esters. Alkyl monoamines and fatty acids having, by preference, 8 to 36 carbon atoms can likewise be suitable.

Waxes can optionally be added to the melt adhesive in quantities from 0 to 20% by weight. The quantity is adjusted in this context so that on the one hand the viscosity is lowered to the desired range, but on the other hand adhesion is not negatively influenced. The wax can be of natural or synthetic origin. As natural waxes, vegetable waxes, animal waxes, petrochemical waxes can be used. Hard waxes such as montan ester waxes, sarsol waxes, etc. can be used as chemically modified waxes. Polyalkylene waxes and polyethylene glycol waxes are utilized as synthetic waxes. By preference, petrochemical waxes such as petrolatum, microwaxes, and synthetic waxes are used, in particular polyethylene waxes, polypropylene waxes, optionally PE or PP copolymers, Fischer-Tropsch waxes, paraffin waxes, or microcrystalline waxes.

Stabilizers are a further group of additives. Their purpose is to protect the polymers from breakdown during processing. The antioxidants may be mentioned here in particular. They are added to the melt adhesive usually in quantities of up to 3% by weight, by preference in quantities from approximately 0.1 to 1.0% by weight. Such additives are known in principle to the skilled artisan, who can made a selection on the basis of the desired properties of the melt adhesive.

A particular embodiment of the invention utilizes in a melt adhesive according to the present invention, in addition to the polyol or polyol mixture, pigments that are sensitive to microwave radiation. Examples of such pigments are carbon black, iron oxide pigments, finely divided iron pigments. These can be usual finely divided pigments having a particle size between 0.2 and 5 μm, or nanoscale pigments. These can be used in a quantity from 0.5 to 10% by weight, in particular 1 to 5% by weight, based on the entire melt adhesive.

The melt adhesives are manufactured using known processes. For example, the polymers can be made ready and melted, then the resins and/or polyols are added. The additives can then be mixed in. Mixing can take place using known mixing equipment, for example heated agitator vessels or dissolvers; it is likewise possible to melt and mix the components of the melt adhesive in kneaders or extruders. Such processes are known to the skilled artisan and require no further explanation. After mixing, the melt adhesive can be cooled, portioned, and packaged.

Selection of the polyols having a high boiling point ensures that bubbles do not occur during manufacture or upon application of the melt adhesive. This avoids contamination of the application equipment, and likewise ensures a uniform adhesive layer and sufficient adhesion.

The melt adhesive according to the present invention is intended to be substantially free of water or low-boiling alcohols. Such substances are to be present only to the extent that they are contained as impurities in the starting raw materials. A further reduction in these impurities can also be achieved by way of the manufacturing process, the mixtures being heated to temperatures above 100° C. and/or degassed under vacuum.

The application process depends on the nature of the substrate to be bonded, and the machines suitable therefor. Spot application, area application, or strip application can also be involved. Application can be effected using known equipment, for example by applying using spray nozzles or applicator nozzles, using wide-slot nozzles, blades, or roller application systems.

The melt adhesives according to the present invention have a viscosity that is matched to the application process. The melt adhesives possess a viscosity from 100 to 30,000 mPas, by preference 300 to 20,000 mPas, in particular 500 to 10,000 mPas, at a temperature of 160° C. (viscosity measured using Brookfield Thermosel, spindle 27, at the temperature indicated). Melt adhesives that have a viscosity between 500 and 10,000 mPas, in particular up to 5000 mPas, at application temperature, e.g. at 100 to 150° C., are particularly suitable.

Upon utilization, it is advisable to use a melt adhesive having the lowest possible viscosity at the application temperature. This ensures better applicability and makes the hot-melt adhesive easier to deliver. Wetting of the substrate is likewise promoted thereby. After application onto a substrate surface, the side of the melt adhesive facing the air must remain tacky and adhesive for as long as possible. Selection of the polymer components to be used according to the present invention yields a long open time; in other words, bonding to the second substrate surface is possible even after a longer period of time. Once both substrates have been pressed onto the melt adhesive, a relatively short curing time for the melt adhesive is achieved.

The melt adhesives according to the present invention exhibit a rapid heating rate under microwave irradiation. The heating rate is to be achieved even in thin layers. The heating rate, measured in a layer 1 mm in thickness in a commercially usual microwave oven having a power level of 700 watts, is to be at least 20° C. per minute, in particular at least 30° C. per minute. Temperatures above 80° C., in particular above 100° C., particular above 150° C., are to be achieved in this context.

The melt adhesives according to the present invention are utilized for bonding of substrates such as unvarnished or coated paper or corresponding cardboards, films, plastics, or glass, and for other substrates. In particular, containers such as folding boxes, outer cartons, trays, and film packaging materials can be manufactured therewith. The melt adhesives according to the present invention are notable in particular for very good adhesion to the aforesaid substrates. Particular suitability exists for adhesive bonds that are exposed to low temperatures during storage. The surfaces bonded in this fashion remain flexible even at low temperature. In addition, the adhesive bonds made with the adhesive according to the present invention exhibit good bond strength without losing flexibility, cracking, or exhibiting a detectable loss of cohesion.

A further object of the invention is to make available a process for reopening bonded packages by means of microwave radiation. In accordance with the process according to the present invention, two substrate surfaces are bonded using a melt adhesive according to the present invention. It is possible in this context to fasten the bonded surfaces using a spot-type adhesive bond; it is likewise possible to generate a continuous film between two substrate surfaces to be bonded; an opening in a substrate surface can also be sealed with a drop of adhesive. For the case in which the bonded seam seals a package, the adhesive layer counteracts the diffusion of liquid or gases between the internal space of the package and the outer side, as a seal. Contamination between the inner and outer side is to be prevented. The adhesive layer exhibits good adhesion to both substrates, so that they adhere to one another at usual manufacturing and storage temperatures between −30 and +50° C. The adhesive coating is applied at a thickness from 1 to 500 μm.

When the applied layer of melt adhesive is irradiated, after storage, with electromagnetic radiation in the microwave region, the thin adhesive layer heats up. The cohesion or adhesion of the adhesive with respect to the substrate is thereby weakened, and it is possible to open the adhesive bond.

In contrast to the known melt adhesives, it is surprising that in a short time even a thin layer of the melt adhesive can be sufficiently heated by microwave radiation that the cohesive/adhesive force is greatly diminished. Heating is to occur in this context to a temperature between 80 and 250° C., in particular to a temperature between 100 and 180° C. Heating can occur, depending on the configuration of the radiation source, in a time period between 30 seconds and 20 minutes.

The melt adhesive according to the present invention and the process for sealing two piece of substrate are suitable in particular for a package that contains foods or similar objects. It is then possible to heat such packages in their entirety using microwave radiation, in which context piece of the substrate bonded with the adhesive according to the present invention are heated and can be reopened. Optionally, it is also possible to heat only the bonded surface with microwave radiation, and to soften the thin adhesive layer only there.

The melt adhesive for the process according to the present invention is intended to contain no substances that vaporize quickly under these conditions. It is thereby possible to ensure that bubbling and spattering do not occur during heating, and that no contamination of the contents of the package occurs as a result of the melt adhesive seam.

The process according to the present invention is suitable in particular for bonding of packages that are to be reopened. The melt adhesives according to the present invention can easily be reheated above their softening point by being heated in microwave radiation, even in the presence of the contents. The cohesion of the adhesive layer between the two pieces of substrate is thereby diminished. It is then possible to mechanically separate the two bonded pieces of substrate from one another. In another preferred embodiment, it is also possible for a mechanical stress to occur between the two bonded pieces of substrate as a result of the heating of the packaging material. In this case it is possible for the bonded site to open up by itself thanks to the resulting stresses, without additional mechanical action. The stress can occur as a result of the heating of the packaging material by the substrate material; it is also possible for a design-related stress to be permanently present and to be immobilized in the bonded state by the adhesive bond.

In an embodiment of the substrates to be bonded, it is likewise possible to manufacture packages that are sealed under usual storage conditions but exhibit, at one site, an opening closed off with an adhesive according to the present invention. When a package that is at least partly bonded using a melt adhesive according to the present invention, or comprises a corresponding opening, is heated along with the contents, a positive pressure can build up in the internal space because of the package contents. As a result of the decreased cohesion/adhesion of the adhesive bond, it is possible for the internal pressure to separate the bonded pieces of substrate from one another at predefined break site, thus releasing the positive pressure into the environment.

After removal of the package from the region of the microwave radiation, the melt adhesive can cool off and it loses its tack. Dripping, smearing, or sticking to other surfaces can thereby be avoided. By selecting suitable raw materials that are approved under food- or drug-related legislation, it is possible to use adhesives according to the present invention in packaging for corresponding products.

The melt adhesive according to the present invention is notable for good processability and adhesion of the adhesive bonds; low-temperature flexibility is also high. A bonding process according to the present invention ensures good sealing of the adhesion site, and these adhesive bonds can be released again at high temperature by way of a brief energy input using microwave radiation. The substrate surfaces are easily detachable; alternatively, the bonded sites separate as a result of stresses that are provided between the pieces of substrate.

The present invention is described below in further detail using examples.

### EXAMPLES

All quantitative indications in %.

The constituents were mixed to yield a melt adhesive by being heated and homogenized

| | |
|---|---|
| EVA | Escorene UL 40028 |
| Resin | Escorez 5300 |
| Wax | Sasol wax H 1 |
| Additive/stabilizer | Irganox 1010 |

| No. | EVA | Resin | Wax | Additive | Polyol | Pigment | |
|---|---|---|---|---|---|---|---|
| 1 | 30 | 45 | 24.9 | 0.1 | | | Comparison |
| 2 | 35 | 40 | 19.9 | 0.1 | | | Comparison |
| 3 | 30 | 42.5 | 22.4 | 0.1 | 5 glycerol | | |
| 4 | 35 | 37.5 | 17.4 | 0.1 | 5 glycerol | | |
| 5 | 30 | 42.5 | 19.9 | 0.1 | 2.5 glycerol | 2.5 iron oxide | |
| | | | | | | powder | |
| 6 | 30 | 45 | 24.9 | 0.1 | 5 polyvinyl alcohol | | |

Viscosity (160° C., mPas)

| 1 | 2 | 3 | 4 |
|---|---|---|---|
| 950 | 1300 | 900 | 1250 |

A cardboard was coated with a melt adhesive according to Examples 1 to 6 and bonded to an identical substrate over a width of 1 cm. The adhesive bond was solid after bonding; without substrate breakage, the substrates could no longer be separated by manual tearing.

Pieces of PE film were bonded in similar fashion. The bond was flexible even at low temperature.

The corresponding bond was placed in a microwave for a period of 5 minutes. The microwave source had a power level of 700 watts.

After removal of the adhesive bond from the microwave radiation, the bonded substrates could be separated from one another by manual pulling.

A sample of Examples 1 to 6 (50 g) was heated in a microwave source, and the temperature was measured. An improved heating rate was observed.

Temperature 100° C.:

| 1 | 2 | 3 | 4 | 5 | 6 |
|---|---|---|---|---|---|
| 5 min. | 5 min. | 1.5 min. | 2 min. | 1.5 min. | 3.5 min. |

1. A hot melt adhesive comprising:
a) greater than 50%, by weight based on the amount of base polymer, of a thermoplastic polymer which
i) contains ethylene-vinyl acetate based copolymer; and
ii) optionally contains polar functional groups; and
b) 0.5 to 15%, by weight based on the amount of base polymer, of at least one polyol having a boiling point greater than 120° C.;
wherein the adhesive heats up and decreases its adhesive properties upon a microwave irradiation.

2. The hot melt adhesive according to claim 1, wherein the polyol is selected from 2- to 6-functional alcohols and have a boiling point greater than 150° C.

3. The hot melt adhesive according to claim 1, wherein said adhesive has a viscosity range of 300 to 20,000 mPas at the application temperature

4. The hot melt adhesive according to claim 1, wherein said adhesive has a heating rate greater than 20° C./minute at 700 watts and 1 mm thickness.

5. The hot melt adhesive according to claim 4, wherein said adhesive has a heating rate greater than 30° C./minute at 700 watts and 1 mm thickness.

6. The hot melt adhesive according to claim 4 further comprising 0.1 to 15%, by weight based on the total adhesive, of carbon black, iron powder, iron oxide pigments and mixtures thereof.

7. The hot melt adhesive according to claim 6 further comprising 0.5 to 7.5%, by weight based on the total adhesive, of carbon black, iron powder, iron oxide pigments and mixtures thereof.

8. The hot melt adhesive according to claim 1 further comprising 5 to 30%, based on the total adhesive, of a resin that has a softening point of 70 to 150° C.

9. The hot melt adhesive according to claim 1 further comprising 2 to 15%, based on the total adhesive, of a plasticizer.

10. The hot melt adhesive according to claim 1 wherein the polyols have a dipole moment greater than 1.85.

11. An article of manufacture comprising the adhesive of claim 1.

12. The article of claim 10 which is a reopenable package.

13. The article of claim 11 wherein the package contains a substrate material of unvarnished or coated paper, unvarnished or coated cardboards, plastic or glass.

14. A process for manufacturing a reopenable package comprising:
a) applying the adhesive of claim 1 onto a substrate;
b) placing a second substrate on the adhesive
thereby forming the reopenable package.

15. The process for manufacturing a reopenable package according to claim 12, wherein the adhesive is applied at a thickness range of 1 to 500 μm.

16. The process for manufacturing a reopenable package according to claim 12, wherein the adhesive has a viscosity of 300 mPas to 20,000 mPas at the application temperature.

17. A process for reopening a bonded package, wherein the package comprises at least two substrates bonded with the hot melt adhesive of claim 1, comprising:
a) irradiating the hot melt adhesive of the package with microwave radiation; and
b) separating the substrates from each other.

18. The process for reopening a bonded package according to claim 15 wherein the adhesive does not foam, spatter or evolve any volatile substances during irradiation.

19. The process for reopening a bonded package according to claim 15 wherein a pressure and or tension is applied to separate the substrates.

20. The process for reopening a bonded package according to claim 15, wherein the irradiation step develops internal space of the package and separates the package at some portion of the bonded package.
